(19) United States
(12) Patent Application Publication
(10) Pub. No.: US 2002/0132218 A1
(43) Pub. Date: Sep. 19, 2002

(54) Rotatable educational device

(76) Inventor: Katherine L. White, Lancaster, OH (US)

Correspondence Address: DAVID A. GREENLEE, P.O. BOX 340557, COLUMBUS, OH, 43234-0557, US

(21) Appl. No.: 10/078,758

(22) Filed: Feb. 19, 2002

Related U.S. Application Data
(60) Provisional application No. 60/276,164, filed on Mar. 15, 2001.

(51) Int. Cl. G09B 19/00; G09B 25/00

(52) U.S. Cl. 434/402; 434/258

(57) ABSTRACT

An educational device and method for educating a student comprising a plurality of pieces that are pivotally interconnected at a center, enabling pivotal movement of each piece about the center relative to the others from a device stored position, in which all pieces are superposed in stacked alignment, sequentially through partial deployment, to a deployed position. Each piece carries a portion of an educational image, such as a shape, object or color on one side, and educational indicia on the other side illustrating the image.

### TECHNICAL FIELD

This invention relates to educational devices and, more particularly, to a device for teaching letters of the alphabet, words and shapes.

### BACKGROUND OF THE INVENTION

Many teaching or educational aids have been developed for use by teachers to assist in teaching students the English alphabet and to assist in the students' efforts to learn to read. These comprise a variety of physical embodiments, including books, flash cards, folding cards, blocks, etc. Also used are a variety of wheel-type devices where letters are rotated past a window to form words. Some of these are shown in U.S. Pat. Nos. 1,671,758—Appley and 3,460,273—Boyd. Some devices use pictures help the student learn to spell simple words, as illustrated in U.S. Pat. No. 270,511—Thomson. However, these devices are unduly complicated and unduly limited in what is being taught.

It is desirable that children learn to read at an early age. Phonics has been found to be the best mode of learning to read. It is also desirable to teach children other simple concepts, such as shapes, fractions, and astronomy. Other teaching aids have been developed to teach each of these concepts.

It would be desirable to provide a single educational aid for teachers to teach the alphabet and words. It is also desirable to provide a single educational device which additionally teaches elementary fractions, shapes and astronomy.

### SUMMARY OF THE INVENTION

It is therefore an object of this invention to provide a single educational aid for teachers to teach the alphabet and words.

It is another object to provide a single educational device which additionally teaches elementary fractions, shapes, colors, astronomy, and emotions.

In one aspect, this invention features an educational device for educating a student comprising a plurality of flat pieces, which are pivotally interconnected at a center. A portion of an educational image is formed on one side of each piece and is fully formed when all pieces are deployed. Educational indicia is carried the other side of each piece, and preferably comprises a different object illustrating that image.

In one example each piece has a word, all having the same initial letter. All pieces except an initial piece also have a picture illustrating the word on that piece. The initial piece also features the upper and lower case depiction of the initial letter. Each piece is sequentially pivoted about the center relative to the others from a device stored position, in which all pieces are superposed in stacked alignment, to a device partially deployed position in, which a piece is pivoted to a position lying adjacent another piece. The device has a fully deployed position, in which all pieces are deployed to form a portion of, or a full, circle.

Preferably, the reverse side of each piece has a portion of an educational image, which, when all pieces are deployed, is a picture illustrating the word on the initial piece. Preferably, all words and pictures relate to circular, spherical or round shapes.

In another aspect, this invention features a method of teaching students, comprising the steps of

providing a device having a plurality of pieces, each carrying a different word on one side of each piece, with all but an initial piece carrying an image illustrating that word on the one side, and each carrying a portion of an image which illustrates the word on the initial piece on the reverse side, said pieces being deployable between stored and fully deployed positions,

deploying each piece when the student identifies the indicia on that piece, and

sequentially deploying all pieces in a predetermined sequence to form the initial piece image.

In one example, the method comprises the steps of

providing a device having a plurality of pieces, each carrying a different word on one side of each piece, with all but an initial piece carrying an image illustrating that word on the one side, and each carrying a portion of an image which illustrates the word on the initial piece on the reverse side, said pieces being deployable between stored and fully deployed positions,

deploying each piece when the student identifies the indicia on that piece, and

sequentially deploying all pieces in a predetermined sequence to form the initial piece image.

These and other objects and features of this invention will become more readily apparent upon reference to the following detailed description of a preferred embodiment, as illustrated in the accompanying drawings, in which:

### BRIEF DESCRIPTION OF THE DRAWINGS

FIG. 1 is a plan view of one side of one embodiment of the educational device of this invention, shown in stored position;

FIGS. 2 and 3 are views similar to FIG. 1, with the device shown in partially deployed positions;

FIG. 4 is a view similar to FIGS. 1-3, with the device shown in fully deployed position;

FIG. 5 is a view similar to FIG. 4, but showing the reverse side;

FIG. 6 is a plan view of one side of another embodiment of this invention;

FIG. 7 is a view similar to FIG. 6, but showing the reverse side;

FIG. 8 is a plan view of one side of another embodiment of this invention; and

FIG. 9 is a view similar to FIG. 8, but showing the reverse side.

### DESCRIPTION OF THE PREFERRED EMBODIMENT

FIG. 1 illustrates one exemplary form of the educational device of this invention 10, shown in stored position. As seen in FIGS. 1-4, device 10 comprises four independent pieces 12, 14, 16, 18, shown as quadrants of a circle, which are pivoted together at a center by a rivet 20. While only four quadrants are illustrated, fewer or more circle sectors could be used.

In FIG. 1, pieces 12, 14, 16 and 18 are superposed on each other, with pieces 14, 16 and 18 stacked beneath initial piece 12. FIG. 4 shows device 10 in fully deployed position, with pieces 14, 16 and 18 deployed from beneath piece 12 to form a full circle.

All pieces carry educational indicia on one side, comprising a different word having the same initial letter, here a. Indicia 22 of initial piece 12 features the word apple the upper and lower case A and a, while pieces 14, 16 and 18 carry images 24, 26, 28 illustrating the words alligator, ant, and arrow, respectively. Note that initial piece 12 does not have an image of an apple.

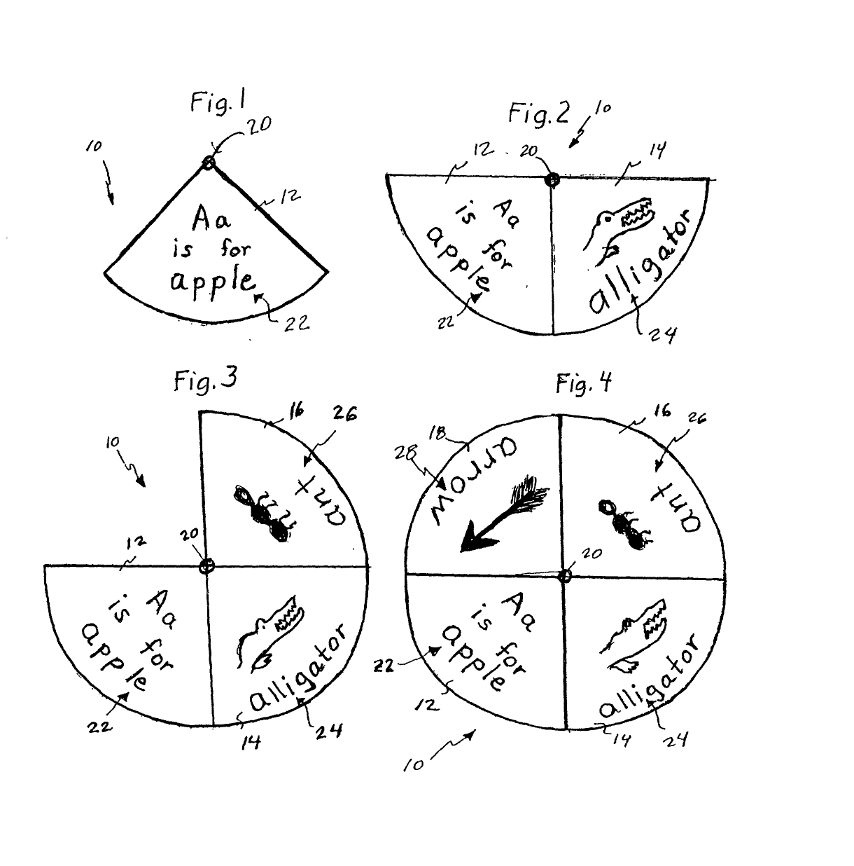

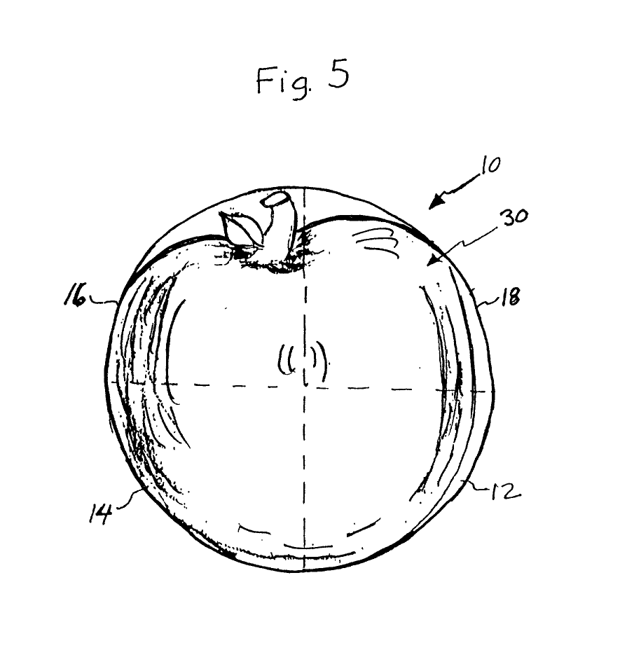

In use, a teacher shows the device 10 in its FIG. 1 stored position to a student and has him identify the initial letter “a” and pronounce “apple”. The student is informed that all words to be shown begin with the same initial “a”. Once that is accomplished, the device is partially deployed to the FIG. 2 position, which provides the image clue, and the student is asked to identify and pronounce “alligator”. The lesson similarly proceeds to the FIGS. 3 and 4 positions. Once all pieces have been taught, device 10 is turned over to the FIG. 5 position, in which all deployed pieces have a portion of the illustration for the image 30 of an apple, which is identifiable if the pieces have been deployed in proper sequence.

Device 10 illustrates but one letter of the alphabet. The same invention is applied to all letters b-z also. The common thread is the use of objects having a round, circular or spherical shape as the image on the reverse side of the pieces. Thus, the device relating to the letter “b” can be “balloon”, “h” can be “hoop”, “q” can be “quarter”, and “z” can be “zero”. In this manner, the alphabet, simple words and pronunciation can be taught, plus many elements of knowledge.

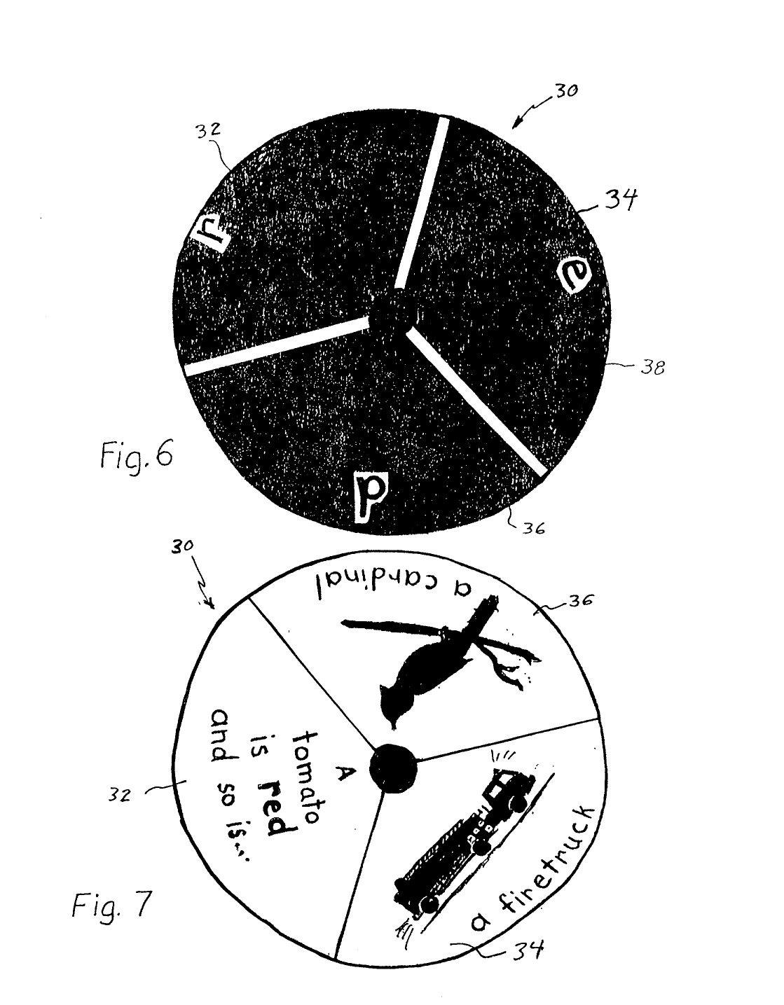

Another embodiment of this invention, designed for teaching the color red and red objects, is shown in FIGS. 6 and 7, where device 30 comprises three segments 32, 34, 36 each of which is colored red. Each also bears one of the letters r, e or d, spelling “red”, and device 30 forms a tomato 38 when deployed. On the reverse side, segment 32 recites the tomato, while segment 34 depicts and names a fire truck, and segment 36 depicts and names a cardinal.

In a similar manner, similar devices (not illustrated) can teach the following colors, with the number of segments equal to the number of letters in that word and having a round object of that color on the one side, and each bearing and naming one of the objects indicated on the other side:

Blue (4 segments): “A blueberry is blue and so is”; the sky; the ocean: a blue bird

Green (5): “A pea is green and so is”: the grass; a leaf; celery; a frog.

Yellow (6): “A sunflower is yellow and so is”: lemon; a school bus; corn; daffodils; Swiss Cheese.

Orange (6): “A basketball is orange and so is”: a pumpkin; a giraffe; orange sherbet; carrots; a flower pot.

Brown: “An acorn is brown”: wood; a football; a potato; a bear.

Purple: “A violet is purple and so are”: grapes; crocuses; eggplants; beets; Barney!

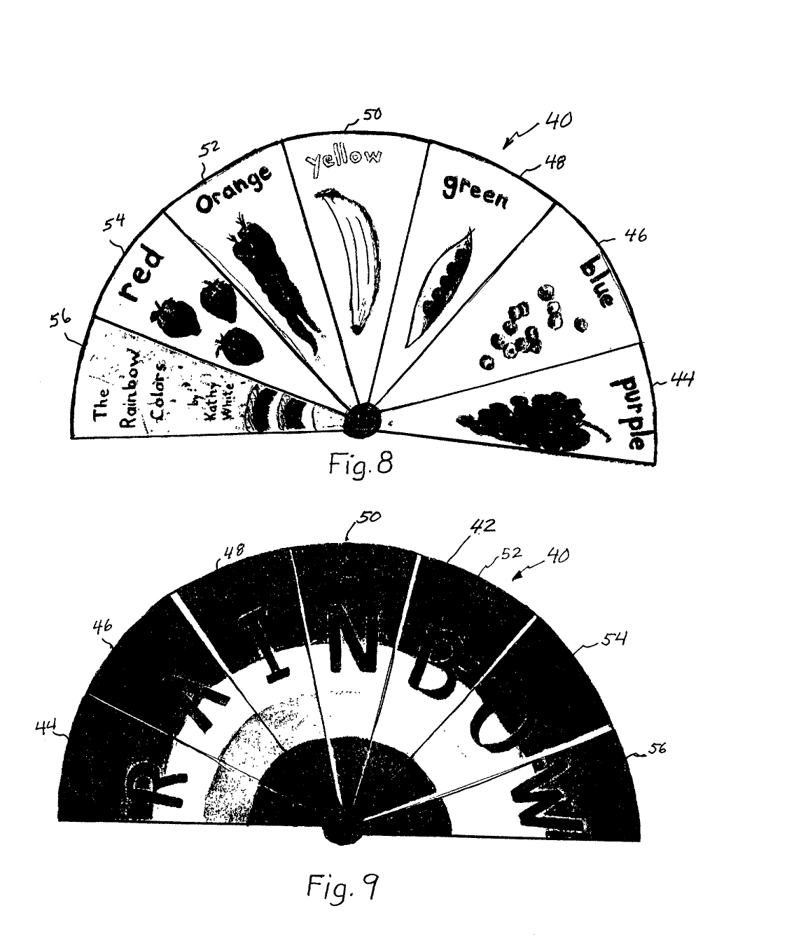

A plurality of colors can also be taught, using objects having the illustrated combination. FIGS. 8 and 9 illustrate a device 50 having a rainbow of colors in the form of a rainbow 42 on one side. When deployed in a semi-circle, segments 44, 46, 48, 50, 52, 54, 56 spell “rainbow”. On their other sides the segments illustrate objects having, and the name of, one of the colors of the rainbow: red (strawberries), orange (carrots), yellow (banana), green, peapod), blue (blueberries) and purple (grapes).

In a like manner, a device (not shown) can teach: “A target is black and white and so is”: a skunk; a Dalmatian dog; a zebra; a checkered flag; a newspaper.

The educational device of this invention is designed to give children (and to adults learning English) primary instruction in a multitude of topics, such as the following:

The alphabet.

Vocabulary: The names of easily recognized objects having the shapes of balls and circles as well as an intuitive understanding of the difference between balls (3 dimensional) and circles (2 dimensional).

Colors and multicolored objects 0,

Phonics: All words chosen embody accepted phonic principles.

Coins: Penny, nickel, dime, and quarter.

Fractions: ¼, ½, ¾, 1.

Astronomy: The sun, moon, planets and earth.

Emotions: Happy face; frowny face.

The educational device is tactile. Children can manipulate each piece, much in the fashion of windows and pop-ups in other children's books.

The educational device is fun. Each letter represents a miniature puzzle, but is simple and easy to solve.

The educational device is easily storable. The letters can be packaged in any number of ways. However, since all pieces are of the same size, they will fit neatly into a round tin partitioned into four sections.

The educational device is durable. If the pieces are made of appropriately thick laminated paper or plastic and fastened together properly, they should last as long as any other well-made children's book.

While only a preferred and alternative embodiments have been described and shown, obvious modifications are contemplated within the scope of this invention, as recited in the following claims.

What is claimed is:

1. An educational device for educating a student comprising
a plurality of pieces,
means pivotally interconnecting all pieces together at a center, enabling pivotal movement of each piece about the center relative to the others from a device stored position, in which all pieces are superposed in stacked alignment, to a device partially deployed position in, which a piece is pivoted to a position lying adjacent another piece, to a device fully deployed position, in which all pieces are deployed, and educational indicia carried by each piece.

2. The educational device of claim 1, wherein each piece is flat, said device having an educational image on one side thereof, a portion of which is carried by each piece, that is formed when the device is in fully deployed position, each piece having a different educational indicia on the opposite side thereof which illustrated said educational image.

3. The educational device of claim 2, wherein all pieces, when deployed, form a circle.

4. The educational device of claim 2, wherein the educational indicia comprises a different word having the same initial letter of the alphabet on each piece, the initial letter on an initial piece, and an image illustrating the word on all but the initial piece.

5. The educational device of claim 4, wherein the reverse side of each piece carries a portion of an educational image, illustrating the word on the initial piece, which is formed in the device fully deployed position.

6. The educational device of claim 2, wherein the educational image is a color, with each piece bearing a letter which, with the other letters, forms a word describing that color when the pieces are deployed, and the educational indicia comprise a different object carried by each piece which illustrates said color.

7. The educational device of claim 6, wherein the object on each piece is accompanied by the name of that object.

8. The educational device of claim 2, wherein the educational image is a plurality of colors forming an image when the pieces are deployed, and the educational indicia comprise a different object carried by each piece which illustrates said image, plus the name of that object.

9. The educational device of claim 2, wherein the educational image is a rainbow, with each piece bearing a letter spelling “rainbow” when the pieces are deployed in a semicircle, and the educational indicia comprise a different object carried by each piece which illustrates one of the colors of a rainbow, plus the name of that object.

10. A method of teaching students, comprising the steps of
providing a device having a plurality of pieces, each carrying a different word on one side of each piece, with all but an initial piece carrying an image illustrating that word on the one side, and each carrying a portion of an image which illustrates the word on the initial piece on the reverse side, said pieces being deployable between stored and fully deployed positions,
deploying each piece when the student identifies the indicia on that piece, and
sequentially deploying all pieces in a predetermined sequence to form the initial piece image.

11. The method of claim 10, wherein all images relate to circular, round, cylindrical or spherical objects.

12. A method of teaching students, comprising the steps of
providing a device having a plurality of pieces, each carrying a portion of an educational image one side and educational indicia on the other side illustrating said image,
means pivotally interconnecting all pieces together at a center, enabling pivotal movement of each piece about the center relative to the others from a device stored position, in which all pieces are superposed in stacked alignment, to a device partially deployed position in, which a piece is pivoted to a position lying adjacent another piece, to a device fully deployed position, in which all pieces are deployed.
